(19) United States
(12) Patent Application Publication
(10) Pub. No.: US 2017/0142429 A1
(43) Pub. Date: May 18, 2017

(54) VIDEO EXAMINATION METHOD AND SYSTEM

(71) Applicants: LE HOLDINGS (BEIJING) CO., LTD., Beijing (CN); LECLOUD COMPUTING CO., LTD., Beijing (CN)

(72) Inventor: Yuhan JIANG, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,305

(22) Filed: Aug. 31, 2016

Related U.S. Application Data
(63) Continuation of application No. PCT/CN2016/083145, filed on May 24, 2016.

(30) Foreign Application Priority Data
Nov. 13, 2015 (CN) 201510779873.1

(51) Int. Cl. H04N 19/40; G11B 20/10

(52) U.S. Cl. CPC H04N 19/40; G11B 20/10527; G11B 2020/1062

(57) ABSTRACT

A method for video examination and an electronic device are disclosed. The method includes receiving videos to be examined; transmitting the videos to be examined to player for playing and examination; transcoding videos passing examinations; uploading transcoded videos to video display platform. In the embodiment of the present disclosure, the videos to be examined may first be examined, only those videos passing examinations can be transcoded, and then the transcoded videos can be uploaded to the video display platform. By use of the present disclosure, the problem of resource wastage caused by the ineffective transcoding operation can be avoided when transcoded videos fail to pass examinations, thus improving the efficiency of video examination.

### CROSS REFERENCE TO RELATED APPLICATIONS

This application is a continuation of International Application No. PCT/CN2016/083145, filed on May 24, 2016, which is based upon and claims priority to Chinese Patent Application No. 201510779873.1, filed on Nov. 13, 2015, the entire contents of which are incorporated herein by reference.

### TECHNICAL FIELD

The disclosure relates to the field of video examination, and particularly to a method for video examination, an electronic device and a non-transitory computer-readable storage medium.

### BACKGROUND

With the rapid changes of internet technology, networks streaming media technology is developing, and social networking technique becomes increasingly popular. As network bandwidth continues to increase, more and more information is being shown on the internet in the form of video and other multimedia forms. Uploading video has become a main form of users' publication of information and entertainment. Users can upload all kinds of videos to cloud server by desktops, laptops, mobile phones and other clients, or watch one of the videos from the cloud server. In light of the above, internet videos are increasingly growing in number, among which there are a lot of redundant, repetitive or even illegal videos such as infringements of intellectual property rights. In the field of video, the regulation of video copyright becomes increasingly necessary. Therefore, each major video site has to examine videos to be uploaded before they “hit shelves.”

In the prior art, it has been a common practice to transcode all the videos to be uploaded and then only examine one transcoded video on each video examination interface before video “hits shelves.” Such examination is conducted one by one. The drawback of this method is that, the work of previous transcoding will become invalid when a transcoded video fails to pass examination, which causes waste of resource. Furthermore, examining one by one could slow down the progress of examinations. Currently, some of videos cannot be timely uploaded to the video site due to the speed of video examination. Therefore, it has been one of industry's concerns on how to improve the efficiency of video examination.

### SUMMARY

In order to solve resources waste problem caused by video examination of the prior art, the present application provides a method for video examination, an electronic device and a non-transitory computer-readable storage medium.

A method for video examination according to one aspect of the present application includes:

receiving videos to be examined;
transmitting the videos to be examined to player for playing and examination;
transcoding videos passing the examination; and
uploading transcoded videos to video display platform.

According to another aspect of the present application, there is further provided a non-transitory computer-readable storage medium storing executable instructions that used to execute any one of methods of the present application as described above.

According to yet another aspect of the present application, there is further provided an electronic device, the device includes at least one processor and a memory for storing instructions executable by the at least one processor, wherein execution of the instructions by the at least one processor causes the at least one processor to execute any one of methods of the present application as described above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram illustrating a method for video examination according to an embodiment of the present application;

FIG. 2 is a schematic flow diagram illustrating a method for video examination according to another embodiment of the present application;

FIG. 3 is a schematic sub-flow diagram for the steps in FIG. 2;

FIG. 4 is an interface of video examination of FIG. 2;

FIG. 5 is a block diagram of a system for video examination according to an embodiment of the present application; and

FIG. 6 is a structural schematic diagram showing a computer system of a terminal device or server according to an embodiment of the present application.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

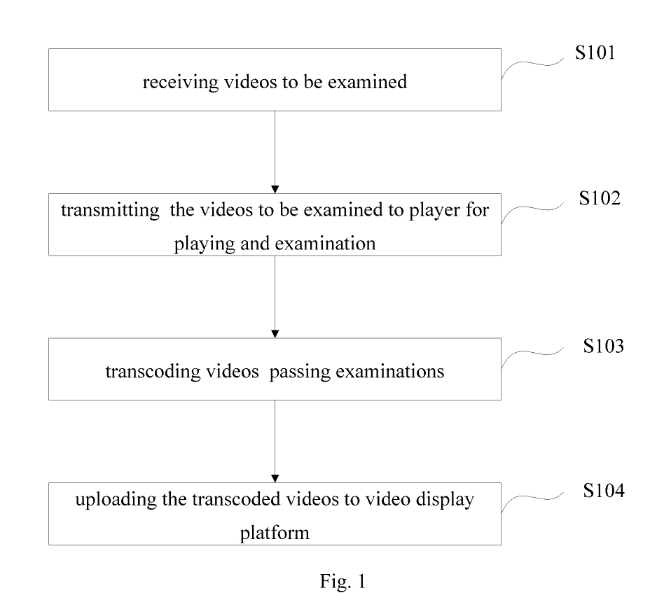

FIG. 1 is a schematic flow diagram illustrating a method for video examination according to one embodiment of the present application. As shown in FIG. 1, the method for video examination comprising:

Step S101: receiving videos to be examined.

In this embodiment, the server receives one or more videos to be examined from a terminal device.

Step S102: transmitting the videos to be examined to a player for playing and examination.

In this embodiment, the videos received by server will be transmitted to a player for playing and examination.

In some alternative embodiments, a player at the server side can only support video decoding and rendering. Therefore, the player may be arbitrarily selected with simple functions and need not to have audio decoding function. Thus, the amount of data being processed by decryption can be reduced, which can not only reduce the hardware configuration requirements, but also improve the speed of video playing.

Step S103: transcoding videos which has passed examination.

In this embodiment, the videos passing examinations can be transcoded on demand by server to match the video format which is required to playback these videos on video display platform.

Step S104: uploading the transcoded videos to video display platform.

In this embodiment, the transcoded videos can be uploaded to corresponding video display platform by server to display. The video display platform may be one of the video sites, such as Le.com.

In some alternative embodiments of the present application, the server may also submit examination results feedback after the videos to be examined are transmitted to player were played and examined. The information, such as a list of videos passing examinations, a list of videos failure to pass examinations and why, etc., may be recorded in examination results feedback. The present application is not limited in this respect.

In the embodiment of the present application, the videos to be examined may first be examined. Only those videos passing examination will be transcoded. Then the transcoded videos will be uploaded to the video display platform. By use of the present application, the problem of waste of resource caused by the ineffective transcoding operation can be avoided when transcoded videos fail to pass examination, thus improving the efficiency of video examination.

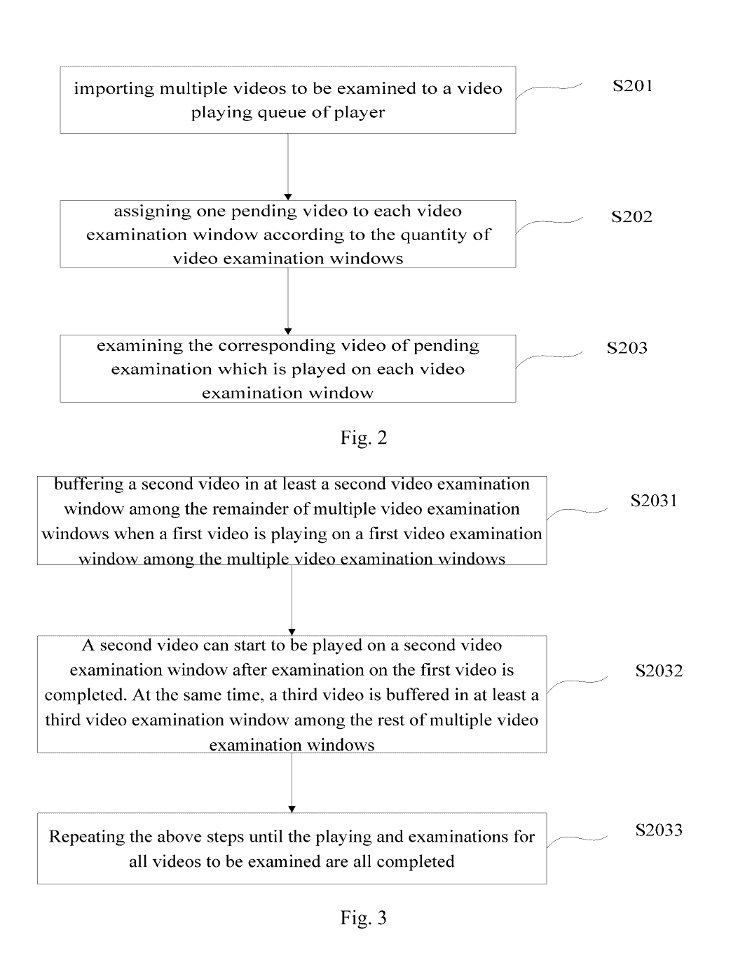

FIG. 2 is a schematic flow diagram illustrating a method for video examination according to a second embodiment of the present application. Only those portions of this embodiment which are different from the above embodiment as shown in FIG. 1 will be described. And the same contents between two are ignored. As shown in FIG. 2, the method for video examination comprising:

Step S201: importing multiple videos to be examined to a video playing queue of player.

In this embodiment, multiple videos to be examined can be imported to a video playing queue of player by server so that the videos can be examined in batch. The player may have multiple video examination windows, the quantity of videos can also be more than one (the quantity of videos is at least 3, such as 20).

Step S202: assigning one pending video to each video examination window according to the quantity of video examination windows.

In this embodiment, the server may assign one pending examination video for each video examination window corresponding to the quantity of video examination windows of player. As such, examining multiple videos concurrently can be achieved.

Step S203: examining the corresponding video of pending examination which is played on each video examination window.

In this embodiment, the corresponding video of pending examination which played on each video examination window is examined by server.

It should be understood that step S201 can be omitted. That is, videos to be examined can be directly sent to every video examination window and do not need to be imported to video playing queue of player.

FIG. 3 is a schematic sub-flow diagram for the step S203 in FIG. 2. As shown in FIG. 3, the method includes the following steps:

Step S2031: buffering a second video in at least a second video examination window among the remainder of multiple video examination windows when a first video is playing on a first video examination window among the multiple video examination windows.

In this embodiment, the server may arrange multiple (such as 20) video examination windows on one interface of video examination, so 20 videos correspond to 20 video examination windows. The 19 videos can be buffered in corresponding 19 remaining video examination windows while a first video played on a first video examination window is examined. Through the above-described embodiment, it can save buffer time and improve the efficiency of video examinations.

Step S2032: A second video can start to be played on a second video examination window after examination on the first video is completed. At the same time, a third video is buffered in at least a third video examination window among the rest of multiple video examination windows.

In this embodiment, when second video is playing on a player on the server side, the corresponding 18 videos can be buffered on remaining 18 video examination windows.

Step S2033: Repeating the above steps until the playing and examinations for all videos to be examined are all completed.

In this embodiment, after the videos to be examined being transmitted to the player are played and examined, examiner may submit examination results feedback thereof using buttons like Pass Examination/No Pass Examination, list and remark box of reasoning of failure in examination.

By using either of embodiments of the present application, the problem of waste of resource caused by the ineffective transcoding operation can be avoided when transcoded videos fail to pass examinations, thus improving the efficiency of video examination. Based on this, multiple (at least 3, for example, 20) videos are extracted at random from all the videos to be uploaded, distributed and displayed on one screen of interface of video examination. A first video can also be selected by default for playing and examination, at the same time, the subsequent videos (subsequent 19 videos) may also be buffered to prepare for subsequent examinations correspondingly. Thus, batch examination for the videos to be examined is realized, which saves time for video examination, and improves the efficiency of video upload.

It should be noted that “server” which the descriptions of FIG. 1 and FIG. 2 refers to, can be a server or server cluster, and may also be a unit for handling related matters or a processor, the present application is not limited in this respect.

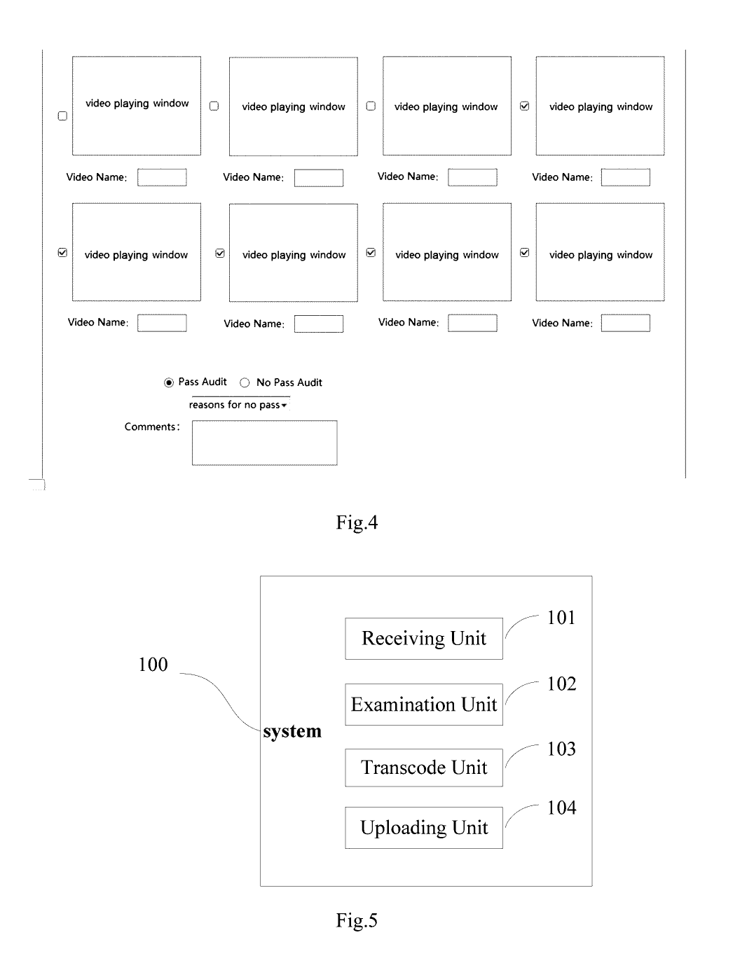

FIG. 4 is an interface of video examination of FIG. 2, which shows an interface of video examination having 8 video playing windows.

As shown in FIG. 4, 8 video playing windows (i.e., the above-mentioned video examination windows) are sequentially arranged on the interface of video examination, a video name box for displaying the name of the video played on video playing window) is respectively arranged at the bottom of each video playing window. Button of Pass Examination, button of Failure in Examination, drop-down list box of reasons of failure in examination and remark box are arranged below 8 video playing windows.

In this embodiment, an interface of video examination can be designed in an interface of video playing. The design of an interface of video examination window can be individualized on demand. For example, the number of video playing windows can be increased or decreased, a video name box can be changed to a video profile box or video ID box, and so on.

Meanwhile, as shown in FIG. 5, a system 100 for video examination is also provided in an embodiment of the present application comprising: a receiving unit 101, an examination unit 102, a transcode unit 103 and an uploading unit 104. The receiving unit 101 is configured to receive videos to be examined. The examination unit 102 includes a transmit module and a player, the transmit module is configured to transmit videos to be examined received by the receiving unit 101 to the player for playing and examination. The transcode unit 103 is configured to transcode the videos of passed examination in the player. The uploading unit 104 is configured to upload transcoded videos to video display platform for display.

In this embodiment, a player can have multiple video examination windows to play and examination each video to be examined. The examination unit 102 can also include a assignment module (not shown in FIG. 5). The assignment module is configured to assign a video examination window for each video to be examined according to the number of video examination windows.

In this embodiment, the player can include a playing module and a buffer module (not shown in FIG. 5). In which the buffer module is configured to buffer a second video on at least a second video examination window among the remainder of multiple video examination windows, in the meanwhile, the playing module is configured to play a first video on a first video examination window among the multiple video examination windows.

The playing module can start to play a second video on a second video examination window after the first video examination is completed. At the same time, the buffer module buffers a third video on at least a third video examination window among the rest of multiple video examination windows.

Repeating the above steps until the playing and examinations for all videos to be examined are completed.

In this embodiment, the system 100 (that is, above-mentioned system for video examination) may also include a feedback unit (not shown in FIG. 5). The feedback unit is configured to submit examination results feedback after the videos to be examined being transmitted to the player are played and examined. For example, examination results feedback can be submitted by using buttons of Pass Examination/Failure in Examination, list box of reasons for failure in examination and remark box.

In this embodiment, the player can only support video decoding and rendering. Therefore, the player may be arbitrarily selected with simple functions and need not have audio decoding function. Thus, the amount of data being processed by decryption can be reduced, which can not only reduce the hardware configuration requirements, but also improve the speed of video playing.

The related functions of each function unit/module in the embodiments of the present application can be achieved by a hardware processor and each corresponding unit.

An embodiment of the present application also provides a non-transitory computer-readable storage medium storing executable instructions that used to execute any one of methods of the present application as described above.

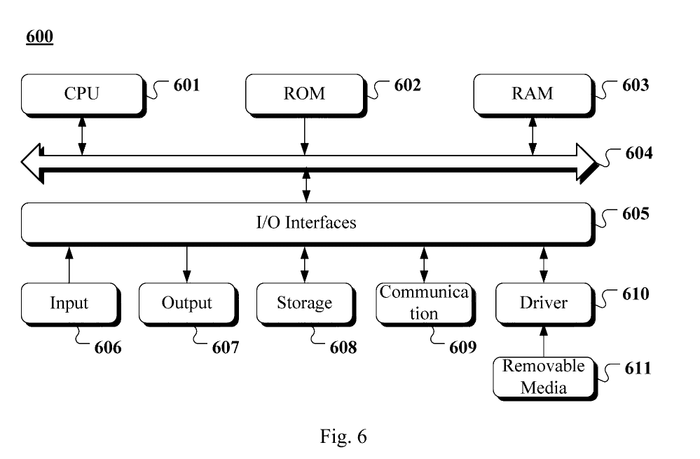

With further reference to FIG. 6, It is a structural schematic diagram showing a computer system 600 of an electronic device such as a terminal device or server according to an embodiment of the present application.

As shown in FIG. 6, the computer system 600 includes a central processing unit (CPU) 601, which can perform various appropriate actions and treatment according to the program stored in a read only memory (ROM) 602 stores or the program loaded to a random access memory (RAM) 603 from the storage part 608. In RAM 603, it also stores various programs and data what required by system 600. CPU 601, ROM 602 and RAM 603 are connected to each other via the bus 604. Input/Output (I/O) interfaces 605 are also connected to the bus 604.

The following components connected to the I/O interface 605 include: an input part 606 such as keyboard, a mouse or the like; an output part 607 such as a cathode ray tube (CRT), liquid crystal display (LCD) or the like and a speaker, etc,; a storage part 608 such as a hard disk or the like; and a communication part 609 such as the network interface card including such as a LAN card, modem, etc. The communication part 609 performs communication via a network such as the Internet. Driver 610 is also connected to the I/O interface 605 as needed. A removable media 611, such as magnetic disks, optical disks, magneto-optical disk, a semiconductor memory, etc., can be installed on the drive 610 on demand in order to read therefrom a computer program which installed on the storage part 608 as needed.

Processor 601 may be a central processor CPU, or specific integrated circuit ASIC (Application Specific Integrated Circuit), or one or more integrated circuits configured to implement embodiments of the present application.

The computer operating instructions may be stored in a read only memory (ROM) 602 or loaded to a random access memory (RAM) 603 from a storage section 608;

A processor for executing the above computer operating instructions stored in each memory, which is used to execute:

receiving videos to be examined;
transmitting videos to be examined to player for playing and examination;
transcoding videos passing examinations;
uploading transcoded videos to video display platform.

Specific operations of the system have been described in detail as above mentioned, and thus a detailed description thereof is omitted.

The above are only some embodiments of the present application. Those of ordinary skilled in the art will appreciate that a number of modifications and improvements to the present application can also be made without departing from the idea of the application, all of which are contained within the protection scope of the present application.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and comprising instructions for execution by a computer device (such as a personal computer, a server, or a network device) to implement methods described by foregoing embodiments or a part thereof.

Finally, it should be noted that, the above embodiments are merely provided for describing the technical solutions of the present application, but not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

1. A method for video examination, comprising:
receiving videos to be examined;
transmitting the videos to be examined to a player for playing and examination;
transcoding videos passing examinations; and
uploading the transcoded videos to video display platform.

2. The method of claim 1, wherein the player includes multiple video examination windows, wherein said transmitting the videos to be examined to player for playing and examination comprises:
assigning a video to be examined for each video examination window according to a quantity of video examination windows; and
playing and examining each pending examination video.

3. The method of claim 2, wherein said playing and examining each pending examination video comprises:
a) at least buffering a second video in a second video examination window among a remainder of multiple video examination windows while a first video is played on a first video examination window among the multiple video examination windows;
b) starting playing a second video on a second video examination window after examination on the first video is completed, meanwhile at least buffering a third video in a third video examination window among the rest of multiple video examination windows; and
repeating the steps a) and b) until the playing and examinations for all videos to be examined are completed.

4. The method of claim 1, further comprising:
submitting examination results feedback after the videos to be examined transmitted to player were played and examined.

5. The method of claim 1, wherein the player supports video decoding and rendering.

6. A non-transitory computer-readable storage medium storing executable instructions that, when executed by an electronic device, cause the electronic device to:
receive videos to be examined;
transmit the videos to be examined to player for playing and examination;
transcode videos passing examinations; and
upload the transcoded videos to video display platform.

7. The non-transitory computer-readable storage medium according to claim 6, wherein said executable instructions, when executed by an electronic device, cause the electronic device to:
assign a video to be examined for each video examination window according to a quantity of video examination windows;
play and examine each pending examination video.

8. The non-transitory computer-readable storage medium according to claim 7, wherein said executable instructions, when executed by an electronic device, cause the electronic device to:
a) at least buffer a second video in a second video examination window among a remainder of multiple video examination windows while a first video is played on a first video examination window among the multiple video examination windows;
b) start playing a second video on a second video examination window after examination on the first video is completed, meanwhile at least buffer a third video in a third video examination window among the rest of multiple video examination windows; and
repeat the steps a) and b) until the playing and examinations for all videos to be examined are completed.

9. The non-transitory computer-readable storage medium according to claim 6, wherein said executable instructions, when executed by an electronic device, cause the electronic device to
submit examination results feedback after the videos to be examined transmitted to player were played and examined.

10. The non-transitory computer-readable storage medium according to claim 6, wherein the player supports video decoding and rendering.

11. An electronic device, comprising:
at least one processor; and
a memory communicably connected with the at least one processor for storing instructions executable by the at least one processor, wherein execution of the instructions by the at least one processor causes the at least one processor to:
receive videos to be examined;
transmit the videos to be examined to player for playing and examination;
transcode videos passing examinations; and
upload the transcoded videos to video display platform.

12. The electronic device according to claim 11, wherein execution of the instructions by the at least one processor causes the at least one processor to:
assign a video to be examined for each video examination window according to a quantity of video examination windows; and
play and examine each pending examination video.

13. The electronic device according to claim 12, wherein execution of the instructions by the at least one processor causes the at least one processor to:
a) at least buffer a second video in a second video examination window among a remainder of multiple video examination windows while a first video is played on a first video examination window among the multiple video examination windows;
b) start playing a second video on a second video examination window after examination on the first video is completed, meanwhile at least buffer a third video in a third video examination window among the rest of multiple video examination windows; and
repeat the steps a) and b) until the playing and examinations for all videos to be examined are completed.

14. The electronic device according to claim 11, wherein execution of the instructions by the at least one processor causes the at least one processor to:
submit examination results feedback after the videos to be examined transmitted to player were played and examined.

15. The electronic device according to claim 11, wherein the player supports video decoding and rendering.
